(19) United States
(12) Patent Application Publication
(10) Pub. No.: US 2006/0069575 A1
(43) Pub. Date: Mar. 30, 2006

(54) Process for advance payment real estate listing

(76) Inventor: William Lawrence Watkins, Woodbury, MN (US)

Correspondence Address: WILLIAM L. WATKINS, JR., 1865 LAMPLIGHT DRIVE, WOODBURY, MN, 55125, US

(21) Appl. No.: 10/949,894

(22) Filed: Sep. 24, 2004

(51) Int. Cl. G06Q 99/00

(52) U.S. Cl. 705/1

(57) ABSTRACT

A process for advance payment real estate listing. with the steps of: Payment for listing real estate is made in advance where the real estate has not yet come to market. Process will use proprietary computer and web based systems for management of information systems and data processing. (a) computer processor for processing data, (b) storage for storing data on a storage medium, (c) first for initializing the storage medium, d) second for processing data regarding cost of service being computed on percentage of present value of home or by average of market value and assessed value as assessed by local assessing authority, (e) third for processing data regarding local real estate and economic market conditions (d) fourth for processing data regarding clients real property. (f) five for processing data regarding buyer of real estate.

### TITLE OF THE INVENTION

A process for advance payment real estate listing.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of residental and commerical real estate and more specifically to a process for advance payment real estate listing as means of providing a more proficient process of listing and selling real estate.

### BRIEF SUMMARY OF THE INVENTION

A primary objective of this invention is to provide an advance real estate listing process

A primary object of the invention is Provide better Return On Investment/R.O.I.

Another object of the invention is Create viable alternate to Discount and Full commission brokerage.

Another object of the invention is Provide wider and longer exposure thus yielding the highest possible price.

A further object of the invention is Provide home consultative services geared toward future sell of the home.

Yet another object of the invention is Cost of service could be tax deductible.

Still yet another object of the invention is Limited Attorney services to program participants.

Another object of the invention is Future buyers could be matched to properties possibly years in advance of the property going on the market.

Another object of the invention is Use of technology will allow homeowner's and buyer's the ability to file and track home improvements.

A further object of the invention is Possible rebates to both seller and buyer after transaction. Still yet another objective of this invention is to provide for a data processing system that tracks all the relevant data involved in home ownership along with data for homebuyers and allow the two parts come to a meeting of the minds with as little involvement from a brokeage as possible.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for advance payment real estate listing. comprising the steps of: Payment for listing real estate is made in advance where the real estate has not come to market. Process will use proprietary computer and web based systems for management of information systems and data processing. (a) computer processor means for processing data, (b) storage means for storing data on a storage medium, (c) first means for initializing the storage medium, d) second means for processing data regarding cost of service being computed on percentage of present value of home or by average of market value and assessed value as assessed by local assessing authority, (e) third means for processing data regarding local real estate and economic market conditions (d) fourth means for processing data regarding clients real property. (f) five means for processing data regarding buyer of real estate.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

The process of prepaying for a real estate listing is a process that allows any present or future homeowner to make payment in advanced before the said real estate goes to market for the service of selling their real estate at some future date. The current process for selling real estate is for the homeowner to pay a brokeage for it's services after the the property has gone to market and sold. With this process the homeowner is likely paying the brokeage a percentage of the sale of the real estate on it's increased value which decreases the owners profit. Decreasing the a profit at a point where the owner is looking for the best return possible is very disheartening especially if the property owner has received less than what was expected for their real estate.

Applying a prepaid method allows the property owner to realize a better Return On Investment(ROI) by reducing the percentage that is charge for listing services and calculating that percentage on current value of the property possible years before it goes to market.

A brokeage that use the business method of prepaid or advanced payment real estating listings require fewer agents. The agents inside these brokeages are now available to assist the property owner with issues concerning the real estate on how it should be maintained or improved to capitalized on increasing its' value before going to market.

As with traditional brokeages the the new methods of listing real estate will use proprietary computer and web based systems for management of information and data. Seller and Buyers will use a modified MLS system(Multiple Listing Service)that will be subscribtions based for public use. Buyers in the market for a home will be able to track homes that have come or are due to come to market throught the modified MLS system. At the same time property owners will use the system to update the property's information.

What is claimed is:

1. A process for advance payment real estate listing. comprising the steps of:
Payment for listing real estate is made in advance where the real estate has not come to market;
Process will use proprietary computer and web based systems for management of information systems and data processing.
(a) computer processor means for processing data;
(b) storage means for storing data on a storage medium;
(c) first means for initializing the storage medium;
d) second means for processing data regarding cost of service being computed on percentage of present value of home or by average of market value and assessed value as assessed by local assessing authority;
(e) third means for processing data regarding local real estate and economic market conditions
(d) fourth means for processing data regarding clients real property.
(f) five means for processing data regarding buyer of real estate.
